(19) United States
(12) Patent Application Publication
(10) Pub. No.: US 2011/0030661 A1
(43) Pub. Date: Feb. 10, 2011

(54) STRATEGY FOR ENABLING INTAKE AIR HEATER TO CLEAN UP WHITE SMOKE DURING WARM ENGINE RE-START IN COLD WEATHER

(75) Inventors: Rogelio Rodriguez, Plainfield, IL (US); Ly V. Tran, Carol Stream, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/534,964

(22) Filed: Aug. 4, 2009

(51) Int. Cl. F02G 5/00; G06F 19/00

(52) U.S. Cl. 123/549; 123/556; 701/113

(57) ABSTRACT

A motor vehicle has an engine compartment (123) and a compression ignition engine (100) disposed within engine compartment (123). Engine (100) has an air intake (110) through which combustion air enters the engine. A heater (120) heats combustion air passing through air intake (110). A sensor (116) indicates temperature in air intake (110). When temperature indicated by sensor (116) is greater than a reference temperature that demarcates a warm engine from a cold engine, a control (102) enables heater (120) to heat combustion air passing through air intake (110) upon engine starting and during a subsequent period of initial engine running whose duration is a function of temperature indicated by sensor (116) at engine starting.

### TECHNICAL FIELD

The technical field of this patent application concerns internal combustion engines, especially diesel engines in motor vehicles, that have intake air heaters for heating intake air during cold starts, and in particular a strategy for enabling an intake air heater to also heat intake air during a warm engine re-start in cold weather so that generation of white smoke during starting and subsequent running is minimized and ideally substantially eliminated.

### BACKGROUND OF THE DISCLOSURE

Starting a cold diesel engine in a motor vehicle is sometimes difficult, especially if the engine has been soaked for an extended time in a cold ambient condition. Various cold weather starting aids, such as glow plugs and block heaters, can facilitate engine starting. Certain diesel engines have intake air heaters that are used in cold weather to pre-heat intake air during cold engine starting and ensuing initial running until the engine warms sufficiently that further pre-heating is stopped.

One type of intake air heater comprises an electric heating element that is controlled by a strategy that is embodied in an engine control system and that utilizes data indicative of intake air temperature to control the flow of electric current to the heating element.

By using an intake air heater to pre-heat cold intake air, the generation of white smoke in exhaust gases leaving the engine exhaust system is minimized and ideally substantially eliminated.

When ambient air that enters the engine air intake is not cold, white smoke is typically not generated, and so pre-heating by the intake air heater doesn't occur.

The intake air temperature data that the strategy uses for control of the intake air heater is typically obtained from a temperature sensor that is disposed at a location in the engine air intake considered suitable for indicating intake air temperature with reasonable accuracy.

When a cold engine is started in cold weather after cold soaking, the temperature sensor is also cold and gives a reasonably accurate indication of the temperature of ambient air entering the intake system.

### SUMMARY OF THE DISCLOSURE

The applicants have observed that an engine having an intake air heater may nevertheless occasionally emit white smoke during cold weather starting. The applicants have further observed that such events occur when the engine, after having been warmed in cold weather, is shut down and then re-started while the engine is still warm. When the engine is housed within a somewhat enclosed engine compartment, the extent to which the engine compartment shields the engine from the ambient surroundings contributes to the amount of time for a warm engine to cool to ambient temperature in cold weather.

The applicants attribute the observed generation of white smoke to various parts of the engine remaining warm enough to cause the air intake temperature sensor to be influenced to some extent by retained heat in various parts of the engine and the engine compartment that houses the engine.

If the temperature sensor is sufficiently influenced by the retained heat, it may falsely indicate sufficiently warm intake air and consequently fail to cause the intake air heater to provide sufficient heating for preventing the temporary generation of white smoke upon starting and ensuing initial running of the engine when cold ambient air is entering and passing through the air intake.

The present disclosure relates to a solution for such situations.

The solution is embodied in a software strategy for enabling the heater to heat intake air during a warm engine re-start in ambient temperatures that are sufficiently cold to make it likely that due to retained heat the temperature sensor is giving a false indication that intake air temperature is sufficiently warm that operation of the intake air heater should not occur. Consequently, the solution can be implemented without use of any additional sensor or sensors to perform clean-up of white exhaust smoke.

A motor vehicle comprises an engine compartment and a compression ignition engine disposed within the engine compartment. The engine comprises an air intake through which combustion air enters the engine, a heater for heating combustion air passing through the air intake, and a sensor for indicating temperature in the air intake.

When temperature indicated by the sensor is greater than a reference temperature that demarcates a warm engine from a cold engine, a control enables the heater to heat combustion air passing through the air intake upon engine starting and during a subsequent period of initial engine running whose duration is a function of the temperature indicated by the sensor at engine starting.

A method for mitigating the generation of white smoke in exhaust gas entering atmosphere from a compression ignition engine housed within an engine compartment of a motor vehicle by enabling an intake air heater to heat combustion air passing through an air intake to the engine upon engine starting and during a subsequent period of initial engine running.

The method comprises evaluating temperature indicated by a sensor disposed at a location in the air intake, and if, upon engine starting, the evaluated temperature exceeds a reference temperature that demarcates a cold engine from a warm engine, enabling the heater to heat combustion air passing through the air intake for a length of initial engine running time that is subsequent to engine starting and that is a function of the evaluated temperature.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a somewhat schematic side elevation view of a diesel engine.

FIG. 2 is a diagram of a portion of an exemplary embodiment of software strategy that provides the solution described above.

### DETAILED DESCRIPTION

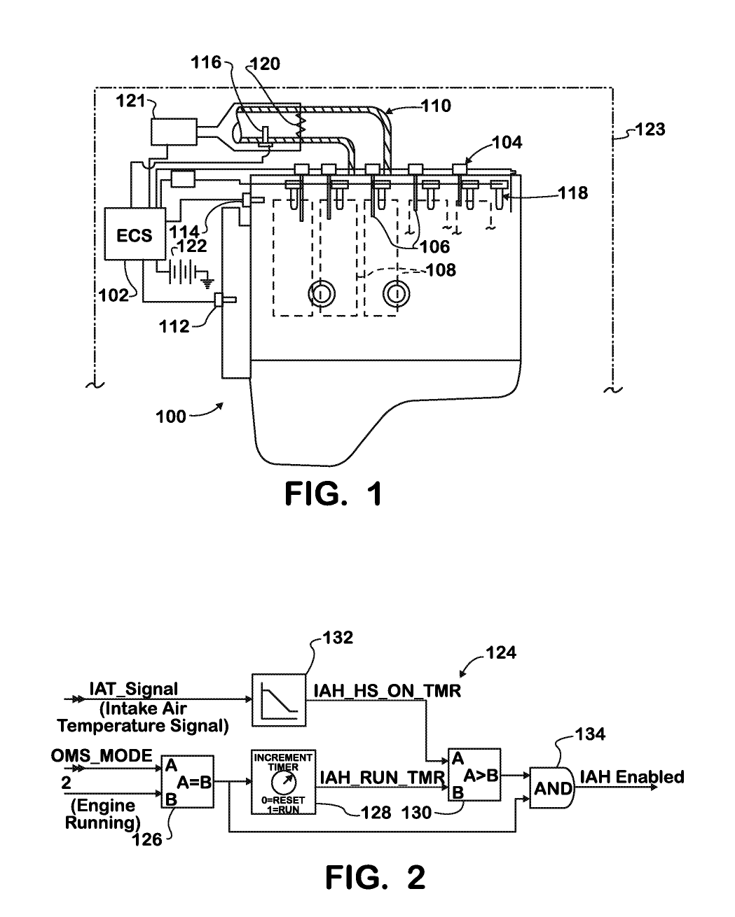

A diesel engine 100, like the one shown in FIG. 1, comprises an engine control system (ECS) 102 that comprises one or more processors that control various systems and devices, one of which is a fuel injection system 104 controlled by a fuel control strategy. Fuel injection system 104 comprises fuel injectors 106 that inject fuel into engine cylinders 108 where the injected fuel combusts to power the engine. Charge air enters cylinders 108 through an air intake system 110 to support combustion.

Measurement of various temperatures related to operation of engine 100 are performed by various sensors such as a coolant temperature sensor 112 associated with the coolant system at a suitable location and an oil temperature sensor 114 associated with the lubrication system at a suitable location. In the case of air intake system 110, an intake air temperature sensor 116 is disposed at a suitable location in the intake system to measure temperature. The three sensors provide coolant temperature data, oil temperature data, and intake air temperature data respectively to ECS 102.

Because pre-heating of a cold diesel engine should occur, especially if the engine has been soaked in cold ambient conditions, FIG. 1 shows both a glow plug heater system 118 and an intake air heater 120. The latter is associated with intake system 110 and is enabled by a strategy embodied in control system 102. Actual operation of heater 120, when enabled, occurs when a relay 121 is operated closed by ECS 102 to connect an electric power supply 122 in the vehicle to the heater so that electricity can flow through heater 120 and create heat that is transferred to air in intake system 110.

Engine 100 is housed within an engine compartment 123, shown only schematically in FIG. 1, of a vehicle. Engine compartment 123 provides some degree of sheltering of engine 100 from the ambient environment.

FIG. 2 shows a strategy 124 that is embodied in ECS 102 for enabling operation of heater 120.

The strategy is activated when the engine is placed in an engine running mode by the driver of the vehicle operating the usual switch, commonly called the ignition switch, when starting the engine. The engine running mode is one of several possible modes and is indicated in ECS 102 by the numeral “2”. When the engine is in its running mode, the value of a parameter OMS_MODE assumes a value “2”.

The strategy comprises a logic function 126 that provides a logic “0” output when the value of OMS_MODE is other than “2”, but provides a logic “1” output when the value of OMS_MODE is “2”.

When the output of function 126 changes from a logic “0” to a logic “1”, a timing function (timer) 128 starts to nm. Elapsed time is given by the value of a parameter IAH_RUN_TMR, and that parameter is one input to a logic function 130 that compares the value of IAH_RUN_TMR and the value of a parameter IAH_HS_ON_TM.

Logic function 130 provides a logic “1” output when the value of the parameter IAH_HS_ON_TM is greater than the value of the parameter IAH_RUN_TMR, and otherwise provides a logic “0” output.

Intake air temperature sensor 116 provides an electric signal correlated with its temperature, and that signal is evaluated by ECS 102 to create a value for a parameter IAT_Signal corresponding to the sensor temperature.

The strategy comprises a look-up table, or map, 132 that is populated with various values for the parameter IAH_HS_ON_TM, each such value being correlated with a respective range of values for IAT_Signal. The value for IAT_Signal that is presented to look-up table 132 when the strategy is activated at the commencement of the engine running mode to cause the corresponding value for IAH_HS_ON_TM to be presented to function 130 for comparison with the running time provided by timing function 128.

The values for IAH_HS_ON_TM in look-up table 132 are correlated with values for IAT_Signal such that the greater the evaluated temperature above a reference temperature that demarcates a warm engine from a cold engine, the lesser the value for IAH_HS_ON_TM.

With engine 100 running, the “1” logic output of function 126 is also supplied to one input of a two-input AND logic function 134. The other input of function 134 is the output of function 130. With the engine running and with the temperature indicated by sensor 116 at engine starting being sufficiently high to cause the output of function 130 to be a logic “1”, the output of AND logic function 134 is a logic “1”, enabling heater 120. Assuming that engine 100 continues running, the timer will time out after the amount of time obtained from look-up table 132 at engine starting on the basis of engine temperature has elapsed. Should engine 100 be shut down before the timer times out, the output of function 126 would change from logic “1” to logic “0” at shut down, and consequently change the output of function 134 to unenable heater 120.

The strategy addresses the following situation.

If engine 100 is shut down after having been warmed and re-started shortly thereafter in cold ambient temperature, the engine and associated components will not have had time to cool to ambient temperature. The time for retained heat to dissipate is affected to some extent by engine 100 and associated components being housed inside engine compartment 123 where they are somewhat sheltered even though the usual engine compartment isn't completely sealed off from the outside. In such a situation engine sensor 116 can still be significantly warmer than ambient upon engine starting, and therefore fail to accurately disclose intake air temperature until after it has been sufficiently cooled by intake air flow through air intake system 110. The extent of the inaccuracy depends on various factors but will in general have an inverse correlation with the length of time between engine shut down and re-start.

If function 132 presents a relatively smaller non-zero value for IAH_HS_ON_TM to function 130, a longer elapsed time on timing function 128 will be needed before the output of function 130 switches from a logic “1” to a logic “0” to unenable intake air heater 120, provided that engine 100 is not shut down sooner.

If function 132 presents a relatively larger non-zero value for IAH_HS_ON_TM to function 130, a shorter elapsed time on timing function 128 will be needed before the output of function 130 switches from a logic “1” to a logic “0” to unenable intake air heater 120, provided that engine 100 is not shut down sooner.

What is claimed is:

1. A motor vehicle comprising:
an engine compartment;
a compression ignition engine disposed within the engine compartment;
the engine comprising an air intake through which combustion air enters the engine;
a heater for heating combustion air passing through the air intake;
a sensor for indicating temperature in the air intake;
and a control that when the temperature indicated by the sensor is greater than a reference temperature that demarcates a warm engine from a cold engine, enables the heater to heat combustion air passing through the air intake upon engine starting and during a subsequent period of initial engine running whose duration is a function of the temperature indicated by the sensor at engine starting.

2. A motor vehicle as set forth in claim 1 wherein the control comprises a timer whose nm time sets the subsequent period of initial engine running by starting to run upon engine starting and stopping after an amount of time whose duration is a function of the indicated temperature upon engine starting.

3. A motor vehicle as set forth in claim 2 wherein the control further comprises a look-up table containing various lengths of times each correlated with a respective indicated temperature, and the control operates to select from the look-up table a length of time correlated with temperature indicated by the sensor at engine starting, then to compare the selected length of time with elapsed time on the timer, and then to unenable the heater when elapsed time on the timer equals the selected length of time.

4. A motor vehicle as set forth in claim 3 wherein the look-up table is populated with lengths of times that are inversely proportional to indicated temperature.

5. A motor vehicle as set forth in claim 4 wherein the control further comprises a logic function that unenables the heater if the engine is shut down before elapsed time on the timer equals the selected length of time.

6. A motor vehicle as set forth in claim 1 wherein the heater comprises an electric heating element through which electricity supplied by an electric power supply in the vehicle flows to heat the combustion air.

7. A method for attenuating white smoke in exhaust gas entering atmosphere from a compression ignition engine housed within an engine compartment of a motor vehicle by enabling an intake air heater to heat combustion air passing through an air intake to the engine upon engine starting and during a subsequent period of initial engine running, the method comprising:
evaluating temperature indicated by a sensor disposed at a location in the air intake;
and if, upon engine starting, the evaluated temperature exceeds a reference temperature that demarcates a cold engine from a warm engine, enabling the heater to heat combustion air passing through the air intake for a length of initial engine running time that is subsequent to engine starting and that is a function of the evaluated temperature.

8. A method as set forth in claim 7 wherein the step of enabling the heater to heat combustion air passing through the air intake for a length of initial engine running time that is subsequent to engine starting and that is a function of the evaluated temperature comprises starting a timer upon engine starting to enable the heater and stopping the timer to unenable the heater after an amount of time whose duration is a function of the evaluated temperature upon engine starting.

9. A method as set forth in claim 8 wherein the step of enabling the heater to heat combustion air passing through the air intake for a length of initial engine running time that is subsequent to engine starting and that is a function of the evaluated temperature comprises enabling the heater to heat combustion air passing through the air intake for a length of initial engine running time that is subsequent to engine starting and that is an inverse function of the evaluated temperature.

10. A method as set forth in claim 7 including the step of unenabling the heater if the engine is shut down before the timer has timed out.

11. A method as set forth in claim 7 wherein the step of enabling the heater comprises conducting electricity supplied by an electric power supply in the vehicle through an electric heating element to heat the combustion air.
